(19) United States
(12) Patent Application Publication
(10) Pub. No.: US 2026/0084392 A1
(43) Pub. Date: Mar. 26, 2026

(54) APPARATUS AND METHOD FOR MAKING MOULDED PRODUCTS

(71) Applicant: SACMI COOPERATIVA MECCANICI IMOLA SOCIETA' COOPERATIVA, IMOLA (BOLOGNA) (IT)

(72) Inventors: FABRIZIO PUCCI, IMOLA (BOLOGNA) (IT); FIORENZO PARRINELLO, IMOLA (BOLOGNA) (IT); GIOVANNI MAZZOTTI, IMOLA (BOLOGNA) (IT); ELEONORA BALDUCCI, IMOLA (BOLOGNA) (IT); FRANCESCO PIRAZZOLI, IMOLA (BOLOGNA) (IT); DAVIDE ZANOTTI, IMOLA (BOLOGNA) (IT)

(21) Appl. No.: 19/112,766

(22) PCT Filed: Sep. 22, 2023
(86) PCT No.: PCT/IB2023/059401

§ 371 Date: Mar. 18, 2025

(30) Foreign Application Priority Data
Sep. 23, 2022 (IT) 102022000019536

(51) Int. Cl. B30B 11/02

(52) U.S. Cl. CPC B30B 11/02

(57) ABSTRACT

Apparatus and method for making moulded products that includes a containment body for a predefined quantity of loose material such as powdery, fibrous or granular material. The body has at least one expelling opening for expelling the loose material. The molded products also include a forming chamber having a bottom wall and an access opening configured to be in communication with the expelling opening to allow the passage of the material from the containment body above the bottom wall; and a compacting unit operatively engaged in the forming chamber to compact the loose material and to define a dose in a single body.

This invention relates to an apparatus and a method for making moulded products.

In particular, this invention can be applied for making products obtained starting from doses (or blanks) which are fed within moulding processes to obtain objects of various types.

This invention fits in particular into the sector of making and forming doses obtained from natural and renewable materials, for example cellulose-based materials, generally used for making many objects which are currently made of synthetic polymeric material, in particular but not exclusively in the packaging sector. Cellulose-based materials are advantageously much less polluting and easier to dispose of than synthetic polymeric materials.

As is known, the objects are formed by pressing the doses of cellulose-based material between a male half-mould and a female half-mould.

The doses generally have the shape of a flat disk so that they are easy to transport and to insert between the respective half-moulds.

Those doses are mostly obtained by die cutting a web made with a cellulose-based material.

As is described for example in publication WO2021/037946A1, the cellulose web is continuously unwound towards a forming station where respective punches cut the web into the predefined shape and dimensions. In this way, the doses made in the form of a flat disk are then fed to the moulding stations.

However, that solution has major disadvantages mainly derived from the considerable presence of waste (scrap), obtained during the cutting operations.

In fact it should be noticed that between one disk shape and another, obtained directly on the cellulose web, waste is created which must be removed from the object forming lines. Moreover, to avoid excessive consumption of cellulose material, it is necessary to implement waste recovery steps with the consequent disadvantages in terms of additional operations and processing costs.

Another major disadvantage of the process for making doses described above is derived from the presence of the cellulose web, which is gathered in large reels which are therefore particularly bulky. In this context it should in fact be considered that in order to be able to appropriately form the dose, use is made of a cellulose web which is low density and therefore easily deformable and formable, called “air-laid web”, which due to the fact that it contains a lot of air is particularly bulky.

Finally, another disadvantage of the known process for making doses described above is caused by poor flexibility in obtaining different thicknesses and densities. In fact, the successive moulding processes are carried out, as described above, on the single dose which is made of cellulose-based material starting from a film which normally has constant thickness and density.

In this context, one aim of this invention is to improve the processes for making doses which are intended for processes for forming by moulding.

In particular, a first aim of this invention is to make available an apparatus and a respective method for making doses which can avoid creating waste. In other words, a first aim of this invention is to limit any material scrap and therefore also the related steps of recovery and reuse of the material.

A further aim of this invention is to make available an apparatus for making moulded products which is structurally simple and which does not necessitate the use of very bulky reels of low density cellulose-based material.

Yet another aim is to provide an apparatus and a related method for making moulded products which is particularly versatile in obtaining multi-layered doses.

In particular, the aim of the invention is to be able to obtain doses having different thicknesses and/or densities which are unobtainable if getting doses from a film with uniform thickness.

According to a first aspect of the invention, an apparatus is provided for making moulded products, which comprises:
a containment body for a predefined quantity of loose material such as powdery, fibrous or granular material, said body having at least one expelling opening for expelling said material; and
a forming chamber having a bottom wall and an access opening configured to be in communication with said expelling opening to allow the passage of said material from the containment body above said bottom wall.

Moreover, the apparatus preferably has a compacting unit operatively engaged in said forming chamber to compact the loose material to an intermediate density between the starting density and the final density of the moulded product and to define a dose in a single body which is easily transferable to the mould, deformable and formable.

A method for making moulded products is also provided, which comprises the steps of:
preparing a predefined quantity of loose material such as powdery, fibrous or granular material inside a containment body;
transferring the material contained in the containment body to the inside of a forming chamber.

Advantageously, at the end the loose material is also compacted inside the chamber to define a dose in a single body.

In this way, use of powdery, fibrous or granular material which is dosed and fed to the inside of the forming chamber, allows the dose to be made while avoiding the creation of waste or scrap. The use of large reels is also avoided.

Moreover, by superposing different materials, it is possible to achieve compacting of layers which are different from each other so as to obtain a multi-layered dose. For example, it is possible to superpose a first quantity of cellulose-based loose material and a second quantity of different material. Following the compacting action, the quantities of materials are joined in a single body which defines the dose.

According to a further aspect of the invention, any excess material which comes out of the forming chamber can be scraped and reused in the subsequent steps.

The invention can be better understood and implemented with reference to the accompanying drawings, which illustrate an example, non-limiting embodiment of it, in which:

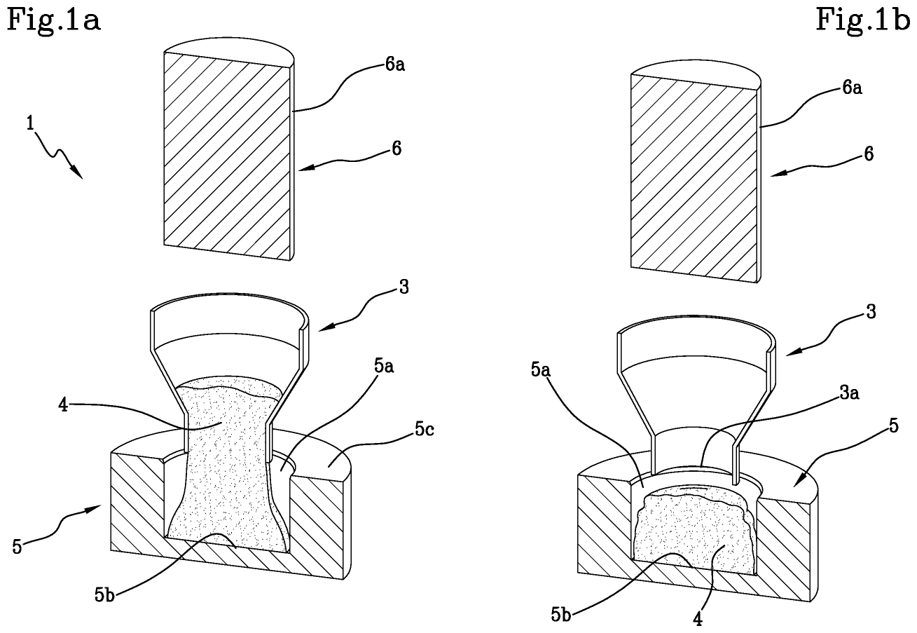

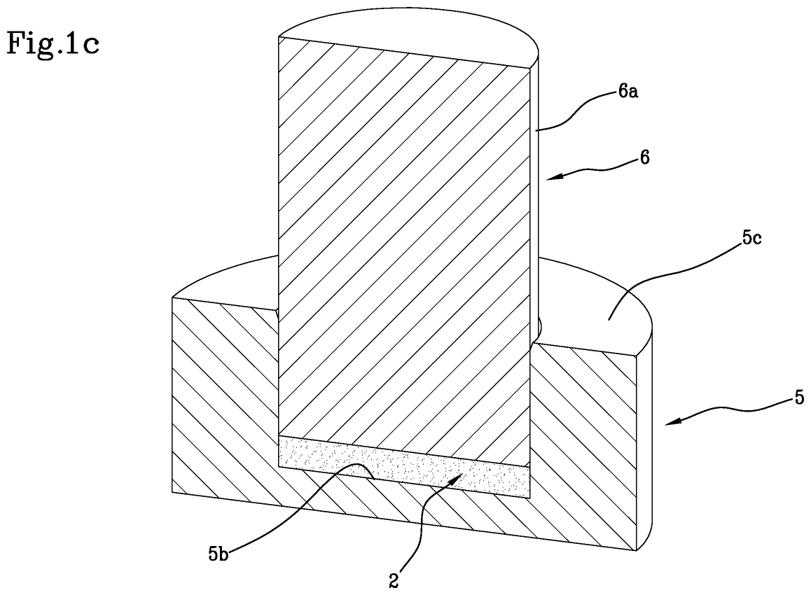

FIGS. 1a to 1c show perspective and partial cross-section views of an apparatus in respective sequences for making doses according to a first embodiment of this invention;

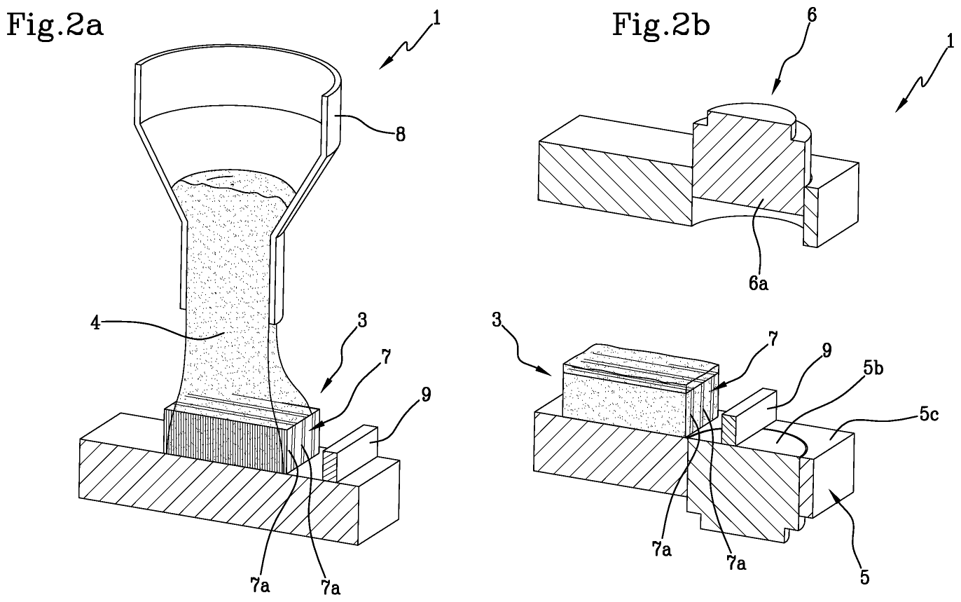

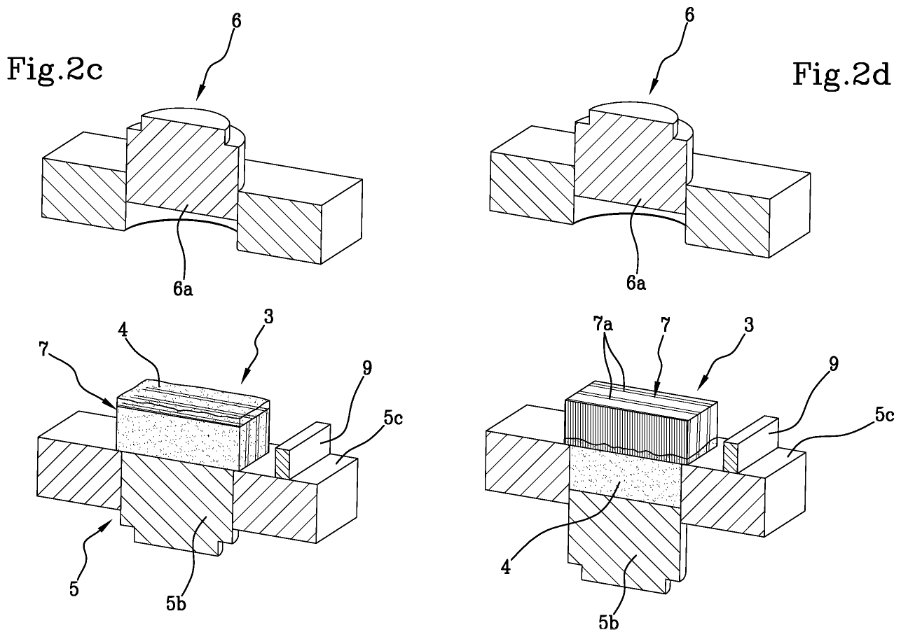

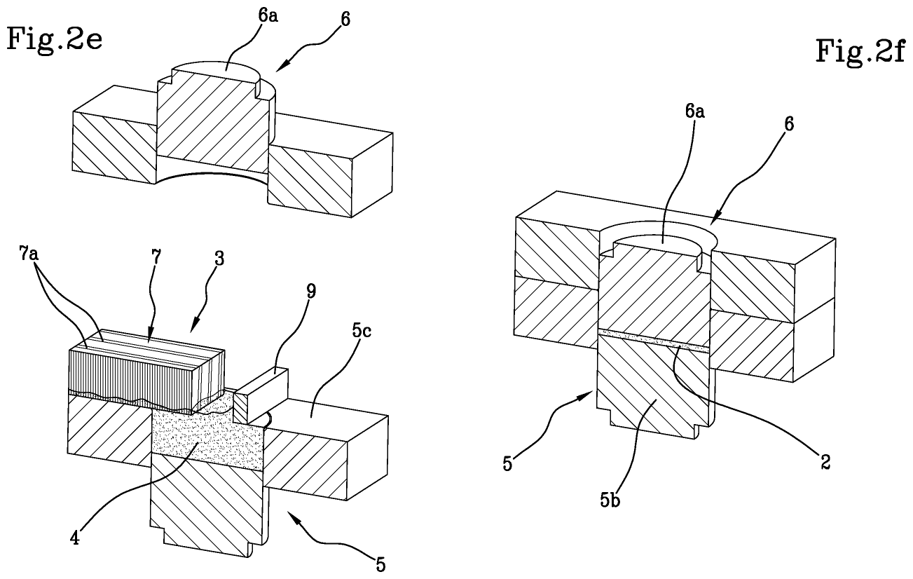

FIGS. 2a to 2f show perspective and partial cross-section views of an apparatus in respective sequences for making doses according to a second embodiment of this invention;

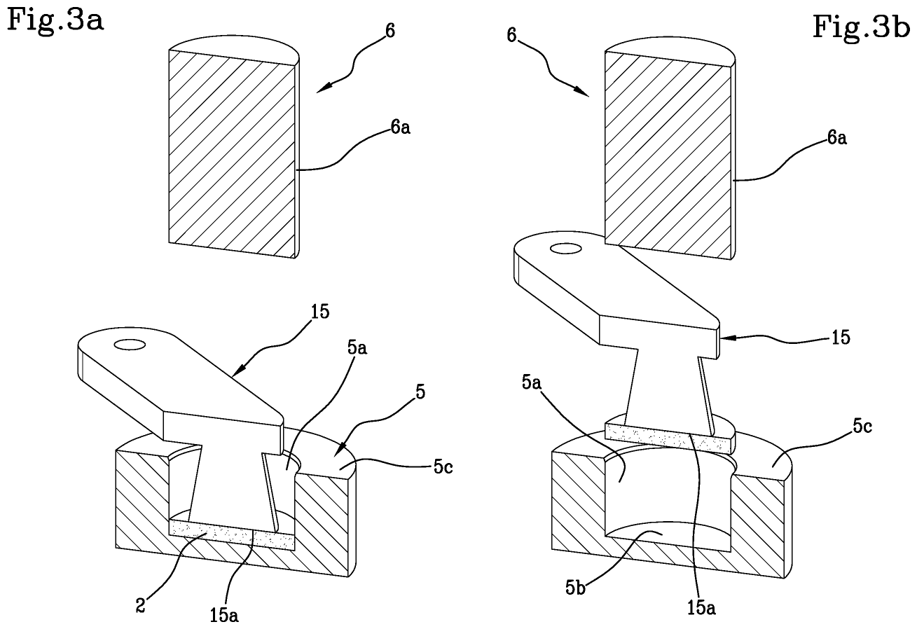

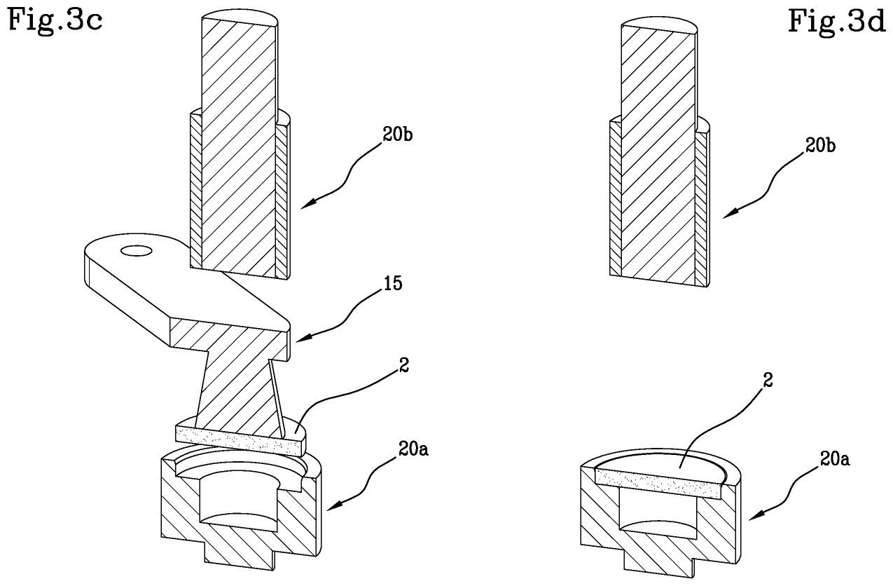

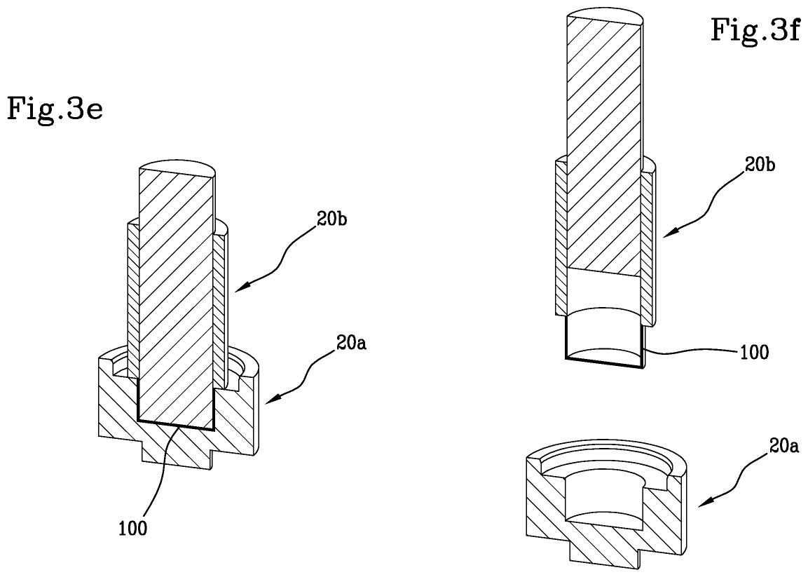

FIGS. 3a to 3f show perspective and partial cross-section views of an apparatus in respective sequences for removing moulding of a dose according to a first embodiment of this invention;

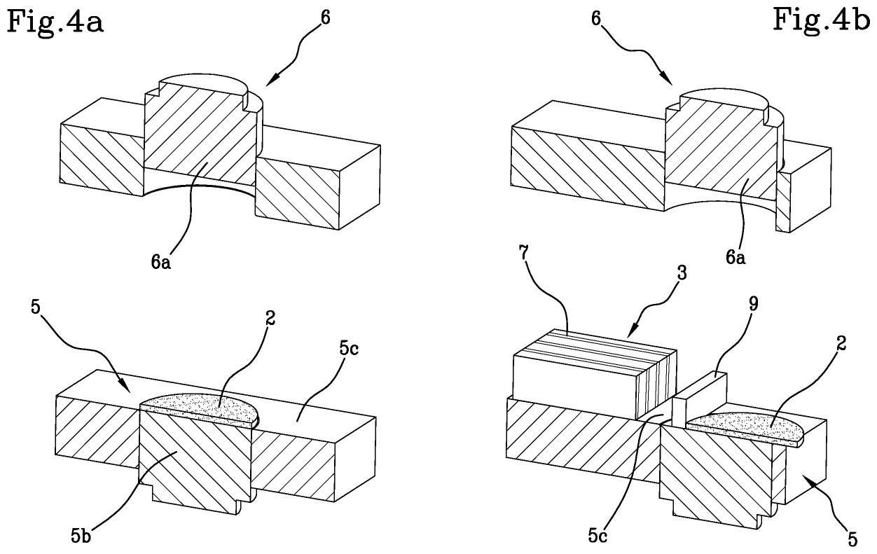

FIGS. 4a and 4b show perspective and partial cross-section views of an apparatus in respective sequences for removing a dose according to a second embodiment of this invention;

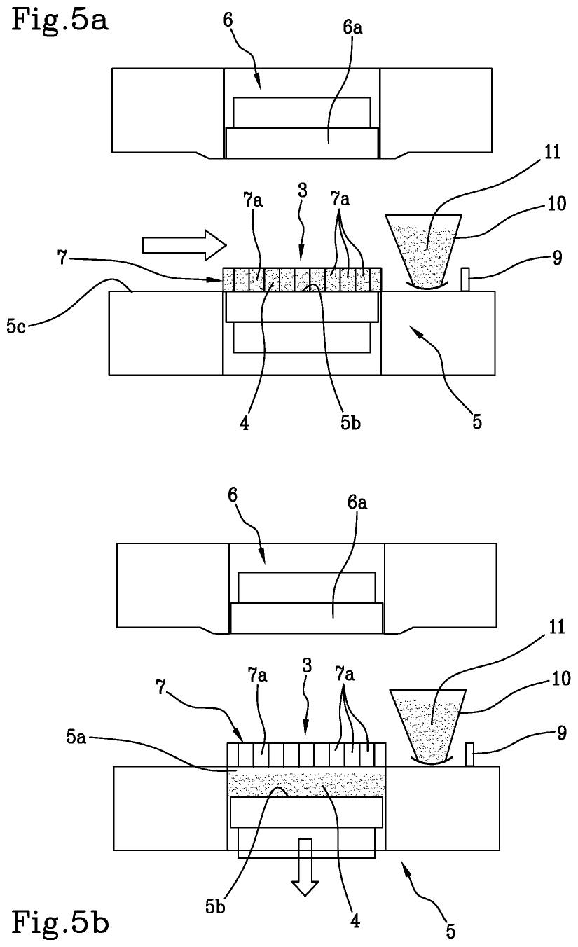

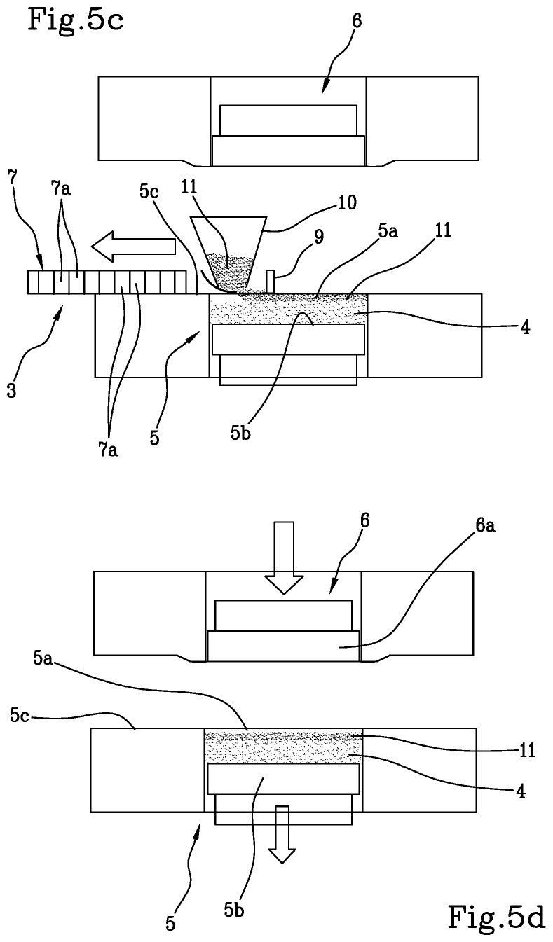

FIGS. 5a to 5d show perspective and partial cross-section views of an apparatus in respective sequences for making doses according to a third embodiment of this invention; and

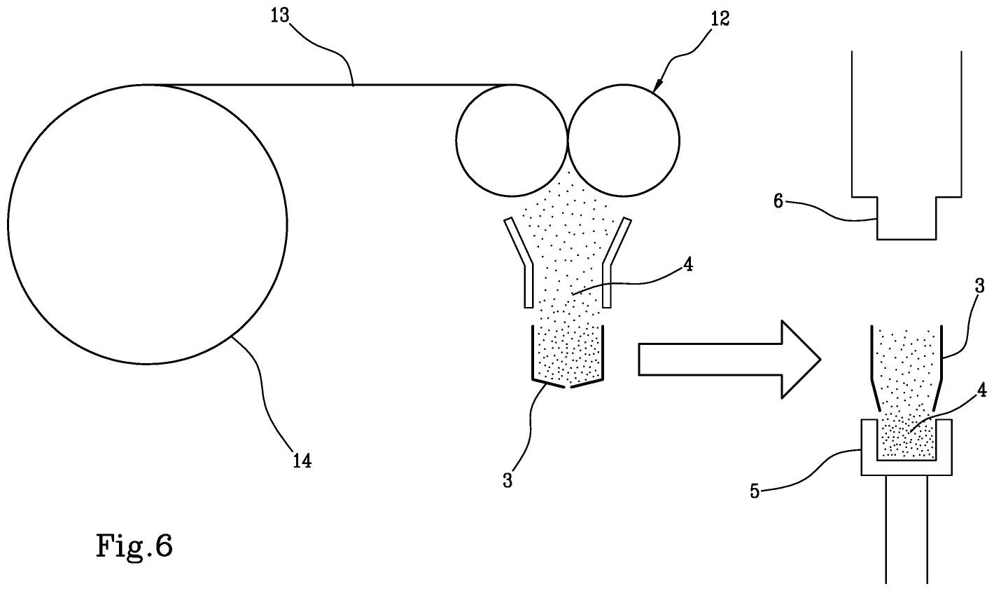

FIG. 6 shows a schematic view of an initial station which is part of the method for making doses according to this invention.

With reference to the accompanying figures, the reference number 1 denotes in its entirety an apparatus for making doses 2 which are intended for processes for forming by moulding.

It should be specified that the doses 2 are preferably made of cellulose-based material. In fact, this invention can be specifically applied for making cellulose-based products. However, it should be noticed that the invention may be used in many contexts and with different materials.

The apparatus 1 comprises a containment body 3 for a predefined quantity of loose material 4, preferably such as powdery, fibrous or granular material.

That loose material 4 is advantageously cellulose powder or fibre.

The body 3 has at least one expelling opening 3a for expelling the material 4, configured to direct the material to the inside of a forming chamber 5.

Preferably, as illustrated in the accompanying figures, the body 3 releases the material 4 by allowing it to fall through the opening 3a towards the chamber 5.

More specifically, the chamber 5 has an access opening 5a configured to be in communication with the expelling opening 3a to allow the passage of the material 4 from the body 3 to the inside of the chamber 5.

Inside the chamber 5 there is also a bottom wall 5b on which the material 4 falling from the body 3 is deposited.

According to the first embodiment illustrated in FIGS. 1a-1c, the body 3 is configured like a hopper for releasing an appropriately dosed quantity inside the chamber 5.

In this embodiment, a compacting unit 6 is provided (FIG. 1c) in the form of a punch 6a which is moved against the bottom wall 5b to compress and compact the material 4 in order to form a respective dose 2 in a single body.

In accordance with a second embodiment illustrated in FIGS. 2a-2f, the containment body 3 is made in the form of a grille 7 defining a plurality of compartments 7a for housing a predefined quantity of loose material 4. In this situation, the compartments 7a cooperating with each other define the above-mentioned expelling opening 3a.

Advantageously, use of the grille 7 allows the entire material 4 to be uniformly arranged inside the body 3. In fact, the compartments 7a have the material 4 equally distributed in them by a hopper 8 (FIG. 2a) which releases the material in the grille 7. In this way, during the step of transferring the material to the inside of the chamber 5, the material 4 itself falls uniformly on the bottom wall 5b.

Also according to the second embodiment, the grille 7 is slidable on an outer surface 5c of the forming chamber 5 on which the respective access opening 5a is made.

The grille 7 moves along a linear path between a conveying condition (FIG. 2b) in which the expelling opening 3a is blocked by the surface 5c and a material 4 releasing position (FIGS. 2c and 2d) in which the expelling opening 3a is coincident with the access opening 5a of the forming chamber 5.

In this situation, the bottom wall 5b of the forming chamber 5 is preferably movable between a raised condition (FIG. 2c) in which it is coplanar with the outer surface 5c to block the access opening 5a, and a lowered condition (FIG. 2d) in which the wall 5b is lowered below the outer surface 5c to allow the material 4 to fall inside the access opening 5a.

Once the material 4 has been released inside the chamber 5, the grille 7 is returned to the initial condition in which the respective expelling opening 3a is blocked by the surface 5c.

A scraping element 9 is also provided which is slidable on the outer surface 5c of the chamber 5 and above the above-mentioned access opening 5a in a first direction approaching the grille 7 (FIG. 2e).

The movement of the scraping element 9 towards the grille 7 allows removal of any excess material 4 from the forming chamber 5. In other words, any part of material projecting outside the access opening 5a is removed from that opening 5a, levelling the material so that it is flush with the surface 5c and returning the excess material towards the grille 7.

Then, as illustrated in FIG. 2f, the material 4 is compressed by the compacting unit 6. In this case, the compacting unit is made up of the punch 6a which is inserted into the chamber 5 and of the bottom wall 5b which is raised towards the punch 6a. The combined action of the punch 6a and of the wall 5b therefore carries out the compression necessary for compacting the material 4 into a dose 2 made in a single body.

Alternatively, the compacting unit 6 may be of the pneumatic type for creating a vacuum inside the chamber 5 and compacting the material 4 defining the dose 2 in a single body.

With reference to the third embodiment shown in FIGS. 5a-5d, the apparatus 1 also comprises a hopper 10 for containing at least one second material 11 insertable inside the forming chamber 5 above the loose material 4. The second material 11 may also be loose (powdery, fibrous or granular) or may be of another type depending on the object to be made.

The hopper 10 is interposed between the containment body 3 and the scraping element 9 and, once the body has been removed from the access opening 5a, is positioned above the chamber to allow the second material 11 to be supplied by falling so that it is above the loose material 4. Advantageously, the scraping element 9 is slidable in the first direction to also remove any excess second material 11 from the forming chamber 5. As shown in FIG. 5c, the hopper 10 and the scraping element 9 are both movable so as to approach the body 3 to deposit the second material 11 and immediately remove any excess quantities.

Advantageously, following the action of the compacting unit 6, the two materials are compacted in a multi-layered single dose 2. It should be specified that there may be any number of hoppers 10 and therefore any number of second materials 11 in order to obtain a dose 2 with two or more different layers of materials.

Moreover, according to the embodiments described above, the containment body 3 may be provided with a suction unit (not illustrated in the figures) for creating a vacuum inside the containment body 3 itself and pre-compacting the loose material 4. In this way, the material 4 falling from the body 3 to the chamber 5 is already partly compacted to facilitate transfer operations into the chamber 5.

Advantageously, a plurality of chambers 5 may be provided, of the type described above and made on the outer surface of a rotary drum. In this case, the outer surface 5c is defined by the cylindrical surface of the above-mentioned drum.

Alternatively, the chambers 5 are made aligned in a single plane.

Additionally, as schematically illustrated in FIG. 6, the apparatus 1 may comprise a grinding unit 12 positioned upstream of the containment body. That unit, for example made up of two rollers rotating in opposite directions grinds a continuous web 13 of cellulose material in order to make the above-mentioned loose material 4. The web 13 is unwound from a respective reel 14 of (cellulose) material which is very compact and therefore not very bulky. The web 13 is unwound towards the above-mentioned grinding unit 12 which feeds the material 4 in the loose form directly to the inside of the body 3.

Alternatively, there may be multiple grinding steps to make the basic material (web) supplied in dense form less and less compact and thus suitable for forming the dose 2.

The apparatus 1 also performs removal of the dose 2 compacted in the chamber 5.

According to a first embodiment illustrated in FIGS. 3a to 3f, a gripping unit 15 is provided for gripping the dose 2 in a single body to extract the dose from the chamber and to feed it to half-moulds 20a and 20b (for forming the finished product).

According to a first embodiment the gripping unit 15 comprises a pneumatic element provided with a suction surface 15a which can be abutted against the dose 2 for retaining it by means of a pneumatic vacuum (FIGS. 3a and 3b).

Alternatively, the gripping unit 15 may comprise at least one pin (not illustrated) partly insertable into the dose 2 for retaining the dose 2 itself by means of mechanical interference. There may be a plurality of pins which, once inserted by interference into the dose 2, retain it for its transfer.

Advantageously, there may be multiple gripping units 15 mounted in line or on a respective rotary carrousel and each configured to move a respective dose 2 to a moulding station.

Moreover, an openable bottom wall 5b may be provided for unloading the dose 2 from below. In this case the dose 2 is not gripped and extracted from the chamber 5 through the opening 5a but is expelled from the opposite side to the opening 5a and following a movement of the bottom wall 5b.

As shown in FIGS. 3c-f , the dose 2 is positioned by the gripping unit 15 at the moulding station and more specifically in the female half-mould 20b. Then the male half-mould 20b is coupled to the female half-mould to deform the dose 2 and to define the shape of the finished product 100 which in the example case in the figures has a cup-like configuration.

In this case too there may be a plurality of half-moulds 20a and 20b mounted on a rotary carrousel.

According to what is illustrated in FIGS. 4a and 4b, the dose 2 can be removed from the chamber 5 by means of the scraping element 9. In fact, in this case, the scraping element 9 is slidable on the outer surface 5c of the chamber 5 and above the access opening 5a in a second direction which is opposite to the first direction, that is to say, away from the body 3. Advantageously, that movement allows removal of the dose 2 previously compacted and therefore lying on the wall 5b which is placed coplanar with the surface 5c.

The invention described above in strictly structural terms, also relates to a method for making doses 2 intended for processes for forming by moulding.

The method comprises the steps of: preparing a predefined quantity of loose material 4 such as powdery, fibrous or granular material 4 inside a containment body 3; transferring the material 4 contained in the containment body 3 to the inside of a forming chamber 5; and then compacting the loose material 4 inside the chamber 5 to define a dose 2 in a single body.

With reference to the diagram in FIG. 6, the step of preparing a predefined quantity of material 4 can be carried out by means of at least one step of grinding a basic material in the form of a sheet or web 13, to obtain the loose or powdery or fibrous or granular form of the material 4.

Once ground, the material 4 is fed directly to the body 3 or to a hopper 8 (FIG. 2a) for transferring the material 4 to the inside of the body 3.

Preferably, the step of transferring the material 4 to the inside of the forming chamber 5 is carried out by releasing the loose material 4 allowing it to fall through an access opening 5a of the chamber 5 itself (FIGS. 1a, 2d, 5b).

Moreover, with reference to the embodiments of FIGS. 2a-2e, 5a-5d, the step of releasing the loose material 4 allowing it to fall is carried out by sliding the containment body 3, which as described above is made in the form of a grille 7, on an outer surface 5a of the chamber 5. The sliding of the grille 7 is carried out from a respective loading zone, until it reaches the access opening 5a.

Advantageously, between the step of releasing the material 4 allowing it to fall and the step of compacting the material 4, the step of removing any excess material 4 from the forming chamber 5 is carried out by the passage of a scraping element 9 in a first direction.

In particular, following the transfer of the material 4 into the chamber 5, the containment body 3 is brought to the loading zone for filling again with more material 4, therefore freeing the opening 5a. Then or simultaneously with that movement of the body 3, the scraping element 9 is made to slide on the surface 5c so that it approaches the body 3. That movement causes removal of material coming out of the chamber 5, which is returned towards the body 3. Therefore, the excess material is again incorporated in the body 3 during a subsequent passage of the body 3 itself (in the form of the grille 7) towards the chamber 5.

Preferably, there may also be a step of pre-compacting the loose material 4 inside the containment body 3 in order to facilitate the transfer of the material 3 into the chamber 5. That pre-compacting action is carried out by depressurisation in the containment body 3 itself.

The method also comprises, before the step of removing any excess material 4 from the chamber 5, the step of depositing at least one second material 11 inside the chamber 5 and above the loose material 4.

That step is carried out by a hopper 10 containing the second material 11 which preceding the scraping element 9 allows the second material to also be deposited inside the opening 5a. Advantageously, the compacting step is carried out on both of the materials inserted into the chamber to make a dose 2 in a multi-layered single body.

It should be specified that the number of materials superposable inside the chamber 5 may be any in order to obtain a dose 2 made of a series of appropriately superposed materials.

For that purpose, there may also be a further step of application of at least one material in sheet form on at least one surface of the dose 2.

In particular, the material in sheet form, generally paper-based and referred to with the term “tissue” given the very low thickness, may be applied inside the chamber 5 before insertion of the material 4. In addition or alternatively, the tissue is positioned on the material 4 already inserted into the chamber 5. In both cases, the compacting action of the punch 6a allows the tissue to be joined to the rest of the material 4 and to thereby define the dose 2 provided with the above-mentioned paper layer.

Alternatively, the tissue is applied after the dose 2 has been formed, on one or more surfaces of the dose 2, by means of appropriate application and/or gluing techniques carried out with specific adhesive substances.

Advantageously, the presence of the tissues allows improvement of the surface appearance of the dose 2, favouring for example application of waterproofing layers or other coatings determined depending on the area of use of the finished product 100.

According to one possible embodiment, the step of compacting the loose material 4 is carried out by creating a vacuum inside the chamber 5.

Alternatively, as illustrated in the accompanying figures, the step of compacting the loose material 4 comprises the step of moving a punch 6a inside the chamber 5 and towards a bottom wall 5b of the chamber 5 to compress the material 4 and to define the dose 2 in a single body.

Advantageously, the step of compacting the material also comprises the step of moving the bottom wall 5b towards the punch 6a to define a combined action crushing the material 4.

The method also comprises, after the step of compacting the loose material 4, the step of removing the previously compacted dose 2 from the forming chamber 5.

That step may be carried out, as shown in FIGS. 4a, 4b, by the passage of the scraping element 9 in a second direction which is opposite to the first, that is to say, away from the body 3. In this way, in the return movement of the scraping element 9 the dose 2 is pushed out of the chamber 5 and towards a subsequent processing station.

Alternatively, the step of removing the dose 2 from the forming chamber 5 is carried out by means of a pneumatic retaining action in which a mechanical arm brings a suction surface into contact with the dose 2 to retain it and to move it towards a pair of half-moulds 20a, 20b (FIGS. 3a-3f). Furthermore, instead of a suction surface, the arm may have one or more pins (not illustrated) for mechanically interfering with the dose 2, retaining it and moving it out of the chamber 5.

Finally, the dose 2 taken from the chamber 5 is fed onto a female half-mould 20a suitable for receiving a male half-mould 20b which forms the dose 2 into the finished product 100 (FIGS. 3e and 3f).

This invention therefore solves the disadvantages of the prior art and brings many advantages.

First, the dose 2 is obtained starting from loose material 4 which can be dosed in the chamber therefore avoiding the creation of waste or other scrap material. Advantageously, the action of the scraping element 9 also allows recovery of the excess material 4 which comes out of the chamber 5 and its reuse for a subsequent filling step.

Moreover, use of powdery or fibrous material allows elimination of large reels and of all of the steps of die cutting the web unwound from the reels. Finally, the invention is particularly versatile since it is usable with any powdery, fibrous or granular material, to obtain different types of dose 2. In fact, by dosing the quantity of material 4 at the infeed of the chamber 5 it is possible to set the thickness and the density, which may even vary, of the dose 2 itself and therefore of the finished product 100. In addition, it is possible to make a multi-layered dose 2, by superposing the respective materials in layers inside the chamber 5.

1. An apparatus for making moulded products, wherein it comprises:
a containment body (3) for a predefined quantity of loose material (4) said body (3) having at least one expelling opening (3a) for expelling said material (4); and
a forming chamber (5) having a bottom wall (5b) and an access opening (5a) configured to be in communication with said expelling opening (3a) to allow the passage of said material (4) from the containment body (3) positioned above said bottom wall (5b);
a compacting unit (6) operatively engaged in said forming chamber (5) to compact the loose material (4) and to define a dose (2) in a single body; and
a pair of forming half-moulds (20a, 20b), movable towards each other to compress a dose (2) and to make the moulded product (100).

2. The apparatus according to claim 1, wherein said expelling opening (3a) of the containment body (3) releases the loose material (4) to the inside of the forming chamber (5) by allowing it to fall.

3. The apparatus according to claim 1, wherein said containment body (3) comprises a suction unit for creating a vacuum inside the containment body (3) and pre-compacting the loose material (4) inside the containment body (3) itself.

4. Apparatus-The apparatus according to claim 1, wherein said containment body (3) comprises a grille (7) defining a plurality of compartments (7a) for housing said predefined quantity of loose material (4); said plurality of compartments (7a) cooperating with each other defining the expelling opening (3a).

5. The apparatus according to claim 1, wherein said containment body (3) is slidable on an outer surface (5c) of the forming chamber (5) on which the respective access opening (5a) is made between a conveying condition in which the expelling opening (3a) is blocked by said surface (5c) and a material (4) releasing position in which the expelling opening (3a) is coincident with the access opening (5a) of the

6. The apparatus according to claim 5, wherein it also comprises a scraping element (9) slidable on the outer surface (5c) of the chamber (5) and above said access opening (5a) and in a first direction to remove any excess material (4) from the forming chamber (5).

7. The apparatus according to claim 6, wherein said scraping element (9) is slidable on the outer surface (5c) of the chamber (5) and above said access opening (5a) and in a second direction which is opposite to the first to remove the previously compacted dose (2) from the bottom wall (5b) of the forming chamber (5).

8. The apparatus according to claim 5, wherein said bottom wall (5b) of the forming chamber (5) is movable between a raised condition in which it is coplanar with the outer surface (5c) to block the access opening (5a), and a lowered condition in which its is lowered below the outer surface (5c) to allow insertion of the material (4) by falling inside the access opening (5a).

9. The apparatus according claim 1, wherein said compacting unit (6) is of the pneumatic type for creating a vacuum inside the chamber (5) and compacting the material (2) in the dose (2) in a single body.

10. The apparatus according to claim 1, wherein said compacting unit (10) is a punch (6a) movable inside the chamber (5) and towards the bottom wall (5b) for compressing the material (4) and defining the dose (2) in a single body.

11. The apparatus according to claim 10, wherein said punch (6a) and said bottom wall (5b) are movable towards each other to compress the material (4) in the chamber and to define a dose (2) in a single body.

12. The apparatus according to claim 5, wherein it also comprises at least one hopper (10) for containing at least one second material (11) insertable inside the forming chamber (5) above said material (4).

13. The apparatus according to claim 12, wherein said hopper (10) is interposed between the containment body (3) and the scraping element (9);
said scraping element (9) being slidable in the first direction to remove any second excess material (11) from the forming chamber (3).

14. The apparatus according to claim 1, wherein it also comprises a gripping unit (15) for gripping the dose (2) in a single body to remove said dose (2) from the forming chamber (5).

15. The apparatus according to claim 14, wherein said gripping unit (15) comprises a pneumatic element for retaining the dose (2) by means of suction.

16. The apparatus according to claim 14, wherein said gripping unit (15) comprises at least one pin at least partly insertable into the dose (2) for retaining the dose itself by means of mechanical interference.

17. The apparatus according to claim 14, wherein it comprises a plurality of gripping units (15) mounted on a respective rotary carrousel.

18. The apparatus according to claim 1, wherein it also comprises a grinding unit (12) positioned upstream of the containment body (3) for grinding a continuous web (13) made of cellulose-based material and making said material (4) in loose form.

19. A method for making moulded products, wherein it comprises the steps of:
preparing a predefined quantity of loose material (4) inside a containment body (3); and
transferring the material (4) contained in the containment body (3) to the inside of a forming chamber (5);
compacting the material (4) inside the chamber (5) and defining a dose (2) in a single body;
wherein it also comprises, after the step of compacting the material (4), the step of compressing the dose (2) between two half-moulds (20a, 20b) to form a moulded product (100).

20. The method according to claim 19, wherein said step of preparing a predefined quantity of material (4) is carried out by means of at least one step of grinding a basic material (13) in the form of a sheet, to obtain the loose material (4).

21. The claim 19, wherein said step of transferring the material (4) to the inside of the forming chamber (5) is carried out by releasing the loose material (4) allowing it to fall through an access opening (5a) to the forming chamber (5).

22. The method according to claim 21, wherein before the step of releasing the loose material (4) allowing it to fall, the step of making the containment body (3) slide on an outer surface (5c) of the forming chamber (5) until it reaches said access opening (5a) is carried out.

23. The method according to claim 19, wherein it also comprises, between the step of releasing the material (4) allowing it to fall and the step of compacting the material (4), the step of removing any excess material (4) from the forming chamber (5) by the passage of a scraping element (9) in a first direction.

24. The method according to claim 23, wherein it also comprises after the step of compacting the loose material (4), the step of removing the previously compacted dose (2) from the forming chamber (3) by the passage of the scraping element (9) in a second direction.

25. The method according to claim 19, wherein it also comprises a step of pre-compacting the loose material (4) inside the containment body (3) by depressurisation in the containment body (3) itself.

26. The method according to claim 19, wherein said step of compacting the loose material (4) comprises the step of moving a punch (6a) inside the chamber (5) and towards a bottom wall (5b) of the chamber (5) to compress the material and to define the dose (2) in a single body.

27. The method according to claim 23, wherein it also comprises, before the step of removing any excess material (4) from the chamber (5), the step of depositing at least one second material (11) inside the forming chamber (5) and above said loose material (4); said dose (2) in a single body being multi-layered.

28. The method according to claim 19, wherein it also comprises the step of removing said dose (2) in a single body from the forming chamber (5) by means of pneumatic retaining and/or by mechanical interference.
